(19) United States
(12) Patent Application Publication
(10) Pub. No.: US 2011/0320957 A1
(43) Pub. Date: Dec. 29, 2011

(54) METHOD AND APPARATUS FOR ANALYZING USAGE PATTERNS AND CUSTOMIZING A GRAPHIC INTERFACE FOR INDIVIDUAL USERS

(76) Inventor: Mark Tiddens, Solana Beach, CA (US)

(21) Appl. No.: 12/953,415

(22) Filed: Nov. 23, 2010

Related U.S. Application Data
(60) Provisional application No. 61/359,329, filed on Jun. 28, 2010.

(51) Int. Cl. G06F 3/01

(52) U.S. Cl. 715/747

(57) ABSTRACT

A method employing software running on a data processor for producing and displaying customized home pages for internet users. The software using established criteria tracks usage by individual users and generates internet home pages for individual users customized to their usage. The system may be configured to run on a local user computer and display, or may be configured to run on a remote server and communicate with the user through a local electronic interface.

### FIELD OF THE INVENTION

This application claims priority to U.S. Provisional Patent Application No. 61/359329 filed on Jun. 28, 2010. The present invention relates to individual users and their use of the internet using computers, televisions, and other computer adapted graphic displays. More particularly it relates to a system for tracking and assessing an individual's usage patterns over the internet, and based on those usage over time, providing and/or continually adjusting one or a plurality of graphic interfaces to each respective user, each interface being adapted to customize the displayed graphic interface and URL links presented to and used by the respective user.

### BACKGROUND OF THE INVENTION

The internet has become part of everyday life in most large industrialized countries. Most users employ some type of computer program adapted “browsing” the internet. Such programs employ screens which generate a graphic interface for the user, allowing them to place curser at positions on the screen and press an input button such as a mouse button, to elicit a response from the computer program. Browsers generally employ “links” which will take the user to another web page when the user places their cursor upon an icon or other graphic link on a first web page, and selects the link by pressing the mouse button or using other means for inputting selection.

Users generally move about from web page to web page, and conventionally start each session and return to, over such sessions, a starting or “home” web page. Frequently, the homepage, for any given user, is simply an existing page on the internet which the individual user has chosen to mark as their homepage. For instance, the website Google is the most visited web page on earth and a chosen homepage of millions of users. However, if users do not actually register with Google or most other search engine providers, their starting page will simply be a search page for the search engine.

Conventionally, internet browsers have evolved to allow individual users employing commercial browser programs to designate a particular web page as their homepage. Subsequent to this designation, their web browser will return to the designated URL address of the designated homepage anytime the browser program is started. While starting with a user-designated home page may be familiar, it does not make traversing the internet for that user any easier or more convenient based on their web usage. A designation of a third party's web page as a homepage for a user simply acts to electronically bookmark it so that their browser can return to it whenever the user chooses to by selecting a homepage icon on the screen, or when the web browser program restarts.

While designating a web page as a homepage for a user allows a familiar page to be displayed to the user subsequently, it is still a webpage with links and input areas that are owned and developed without the user in mind. More often than not, the displayed icons and artwork used to choose links to alternate web pages, are simply paid advertisers. The advertisers' web links are placed on a user's page as an advertisement and not by choice. Consequently, conventional browsers provide a home web page which does not act to ascertain the user's popular usage and visits and therefor fails to provide the user with ease of use or quick links automatically based on use over time. If any bookmarks and links are provided, such are done at the explicit request of the user, based on actions initiated by the user to do so after deciding it is tiresome to continually go through the same mouse and curser actions to accomplish their regular pattern of web browsing.

Consequently, there is an unmet need for a system and method which acts in the background to provide individualized home pages customized for each respective individual users. Such home pages should have software acting and specifically adapted to ascertain each individual user's internet usage, and thereafter act to make it easier for each such user to browse to regularly visited web page destinations. Such an individualized web page should be developed continuously and automatically by the system without the need for an active participation or request by the user, to customize the links on their home page over time, as is the case at present.

In compiling such a personalized web page for each user, such a system should endeavor, in a continuous and ongoing fashion, to ascertain web sites visited by the user continuously, and newly visited pages which repeat, and thereafter undertake to edit the personal home web page employed by each user. The customization takes into consideration the sites visited and how often, as well as new sites visited a plurality of times. Then using software adapted to the task, adapts the user's home page to make it simple and easy to access and to view the content discerned as that of user interest. In doing so, such a system should employ software adapted to automatically assemble one or a plurality of graphic interface screens with graphic interface buttons, which allow the user to visit web sites adapted to their historical habits of internet use.

With respect to the above, before explaining at least one preferred embodiment of the graphic interface device and method herein, in detail or in general, it is to be understood that the invention is not limited in its application to the details of employment and to the arrangement of the components or the steps set forth in the following description or illustrated in the drawings. The various steps, apparatus and methods of the herein disclosed invention for adapting a graphic interface to user habits on an ongoing basis is capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for implementing a user usage tracking system which generates one or a plurality of web pages to aid the user in subsequent user use of the internet. It is important, therefore, that the embodiments, objects and claims herein, be regarded as including such equivalent construction and methodology insofar as they do not depart from the spirit and scope of the present invention.

### SUMMARY OF THE INVENTION

In accordance with the present invention, there is provided an apparatus and method, to continuously analyze a respective individual's usage of the internet over a determined period of time, and thereafter automatically and passively generate one or a plurality of graphic interface pages to be used as home pages which are specifically adapted to aid that respective user in their internet usage.

This system and method herein, provides a means to simplify and render easy access to historically visited sites by users and to view content on the Internet which is specifically adjusted and adapted to each individual user. The home page interface adaptations of each such customized web page, are configured for use by that user, based on their personal previous history of internet usage. The adaptation however is continuous and ongoing, whereby the depicted graphic interface home page for each respective user continuously adapts to their individual usage, without the need for their input. The changes to the graphic interface and displayed links is based on criteria tracked by software adapted to the task including one or a combination of criteria such as the number and duration of visits to individual web sites, related web sites, links on each of the visited web sites, links taken by the user on any of the visited web sites, and repeat visits to individual web sites or the links on any of the individual web sites, and a continuously changing database of known or researched web sites related to or offering similar content to web sites visited by the user. The system in an ongoing fashion, adapts one or a plurality of graphic interface pages adapted to the individual users habits. The system does so without input from the user by changing the icons and links during use or once the user logs off.

The graphic interface pages are adapted to include screens of buttons acting as links to user-preferred sites based on usage and links, as well as commercial web sites. Both fixed and adaptable buttons providing URL links are provided on the displayed user homepage which represent the most popular and ascertained most useful web sites on the Internet.

Additionally, graphics are displayed depicting “Personal Buttons” for URL links for each specific user which are determined and assembled on the graphic interface to allow the user to surf the Internet and which are customized as to their appearance and display in a manner that is customized to each respective user.

In addition to the automatic creation of personal buttons based on usage, users may optionally initiate the creation of their own “Personal Buttons” for placement in designated locations on the assembled and displayed graphic interface of the specific user's home page. Once so created on a homepage of customized graphic interfaces to the user, using software adapted to the task, that user is provided the means to rearrange the created link buttons, be those link buttons generated by the software program based on usage and other criteria, or actually created by the user intentionally.

Still further, using software adapted to the task, the user is afforded the ability to email any of the user-created and software created link icons or buttons from the displayed assembly of link buttons. This option is provided by software adapted to the task through a designation by the user to email one or a plurality of link buttons or icons, which may be by specific command or by a drag and drop of the desired link button onto an icon or interface initialing the email action. Using a lookup table of known email addresses of the user's default or designated email program, the designated link can be sent to any saved email address or any email address input by the user.

The system also includes an option for shortcuts to be placed on the graphic interface page, which are designated as “Super Links” or “Super Macros.” Activation by a user of any of these individual links, will cause software adapted to the task and running on the server monitoring the system, or on the user's computer, to analyze the user's subsequent Internet habits and actions, and based on aforementioned designation criteria, to thereafter suggest one or a plurality of new “Personal Buttons” for inclusion upon the graphic interface assembled and customized for the individual user.

As an example, in one mode, the user clicks on a web page link to cause the browser to visit a particular website, which requires the entry of a password, and then once past the security input stage, the user moves the cursor upon the website to an area of interest where the cursor is again used to designate a choice of viewing. If the user wishes, or should the user repeat this process multiple times, an analytical software routine adapted to the task and running in the background and tracking the user's actions, will suggest or ask if the user would like to create a “Personal Button” shortcut to this webpage, including all of the required password inputs and subsequent chosen link inputs in a series or macro. The software analyzing the user actions will normally suggest the action of the user, however the user may also request the action by activating a request icon. In either fashion, the next time this series of actions is desired by the individual user, instead of multiple inputs by the user, they need only click on an individual icon or button on the displayed customized interface and the system herein will handle all required inputs and subsequent navigation to the final web page.

Over time, the analytical software routing portions of the system herein, running in the background, will ascertain a hierarchy of web sites so visited as a result of using the

Personal Button macro, in a decreasing order of usage. Thereafter the analytical program running on the system herein, will continually rearrange the personal buttons causing these multiple actions to place the personal buttons in an order according to most use.

In use, the system herein and software routines adapted to the specific monitoring and tasks, are configured to act on an ongoing basis to store, and to continually analyze user actions, and sequences of keyboard key inputs, mouse operations and designations, screen cursor positions, and software programs used by the user & web sites visited by the user. In this fashion the system herein can determine connections for individual web sites to continually improve, rearrange, and provide additional inputs for the customized user home page graphic interface and to amend and add interface designations and sequences of actions which will continually customize the homepage for user choices for icon placement, addictions, and subtractions on the home interface page.

Additionally, the software is configured to track and to provide statistics to users on their internet use over time. This data may be employed to suggest or automatically generate the links on the graphic interface assembled to the home page provided the user. This same data is employed for each user to suggest or to create when requested, “super macros” or “super links” that allow one key or mouse click to cause a chain of simulated key inputs, mouse inputs, and internet operations required for a chain event, and to perform such chain events by providing a single icon or graphic for the user on the assembled graphic interface page.

The system herein using various software routines adapted to the various tasks, thus will provide customizable personal icons or buttons, which will move the user to sites where they frequently visit and will create macros or routines for individual buttons to cause multiple chained actions to be taken to visit secure and other sites involving multiple cursor designations and clicks in order. In this fashion, a single button when chosen, will perform the series or complicated chain of individual choices and inputs the user formerly had to under go in a time consuming process. Such an action is especially helpful to those users who are unable to easily or smoothly use a mouse or trackball or the keyboard and who are thus prone to mistakes.

Additionally, the system will provide graphic interfaces employing picture-in-picture and split screens which are available on televisions but not on most computers. While there are some computer systems that have some characteristics of the “Split Screen” component of this invention, such as the ability in Microsoft Windows to right click on the date and choose to

“Show Windows Stacked” or “Show Windows Side By Side”, and such as the Firebox browser add-in called “Fox Splitter” (formerly called “Split Browser”), these programs do not have the complete features of the “Split Screen” component of this invention, such as the automatic sequencing of split screens, and automatic sequencing of the options presented for the screens. Also, these programs run on the local computer which drains the computer's resources and slows it down. The system herein while adapted to run on any computer adapted to run the software routines, can be run either on a local computer or on a remote server. If run on a remote server, the system herein would avoid draining the computer system resources. Thus, the software herein will allow the graphic interfaces of the program to operate independently from the local user's computer “platform” or “operating system.”

Such a remote server running the system would be especially well adapted to server users on closed systems like cable television services, or telephone services which provide internet access. In this mode of use of the system herein, a local processor would be provided to interface between the internet provider's server and a TV or display screen. The local processor would input keys and mouse clicks of the user to the remote server running the system. The server would continuously communicate the video to the local interface which would communicate it to a video screen. Thus users without computers can have customized home pages, and graphic input for internet surfing without the need for a computer. Cable and phone service providers would run the system herein on their servers and the local interface unit will produce displayed video for the user's display screen, and communicate input mouse and key choices from the mouse and keyboard communicating with the local interface unit.

The local interface unit need only have means to communicate user inputs to the remote server, and the remote server's video display to the user's display which will change based on the user's input. The customized home page will thus greet the user on each session, and will continually evolve over time based on each user's habits and usage on the system served by the server of the service provider.

Finally, the system herein, whether run on the user's local computer, or on a service provider's server, using software adapted to the task, will generate graphic interface screens substantially identical to the user's computer graphic interface screen, but employable on the user's smart phone. The user thus has the same screen on the computer screen, the tv screen engaged with server, or their smart phone. Additionally, should the user's use on any electronic device cause either the smart phone version or the computer version of the customized graphic interface screen to change, it will update the other to maintain the substantially similar appearance.

### OBJECTS OF THE INVENTION

It is an object of the invention to provide computer user's with one or a plurality of graphic interfaces for using the internet.

It is another object of the invention to customize the provided interfaces based on the user's ongoing usage of the internet.

It is another object of the invention to provide smart phone graphic interfaces which are substantially the same as the user's computer interfaces and which maintain their identical appearance as either is changed by the user or the program.

A still further object of the invention is to provide software which runs in the background of the user's browser and tracks ongoing usage and makes changes to the customized graphic interface pages based on that ongoing usage.

A still further object of the invention is the provision of web browsing software that will run either on a local user's computer, or upon a remote server communicating with a local display screen, keyboard, and mouse, thereby eliminating the need for a computer or freeing up computer time for other endeavors.

The foregoing has outlined some of the more pertinent objects of the user tracking and graphic interface generation and alerting provided by the apparatus and system herein. These objects should be construed to be merely illustrative of some of the more prominent features and applications of the intended invention. Many other beneficial results can be attained by applying the disclosed system and apparatus in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

FIG. 1 is a graphic depiction a user graphic interface homepage generated by the software running on the processor herein which customizes the links and icons to the individual user usage.

FIG. 2 depicts another mode of the graphic interface assembled by the software running on the processor and arranging icons or buttons which may elicit individual or chain actions to visit web sites the user historically visits.

FIG. 3 depicts one mode of the picture in a picture capability.

FIG. 4 shows a picture in a picture screen having four different screens in which the method herein can be employed to control.

FIG. 5 depicts a simple flow chart of one mode of the system adapted to run on a local user computer.

FIG. 6 depicts a simple flow chart of one mode of the system herein adapted to run on an internet provider's server.

### DETAILED DESCRIPTION OF THE PREFERRED EMBODIMENTS

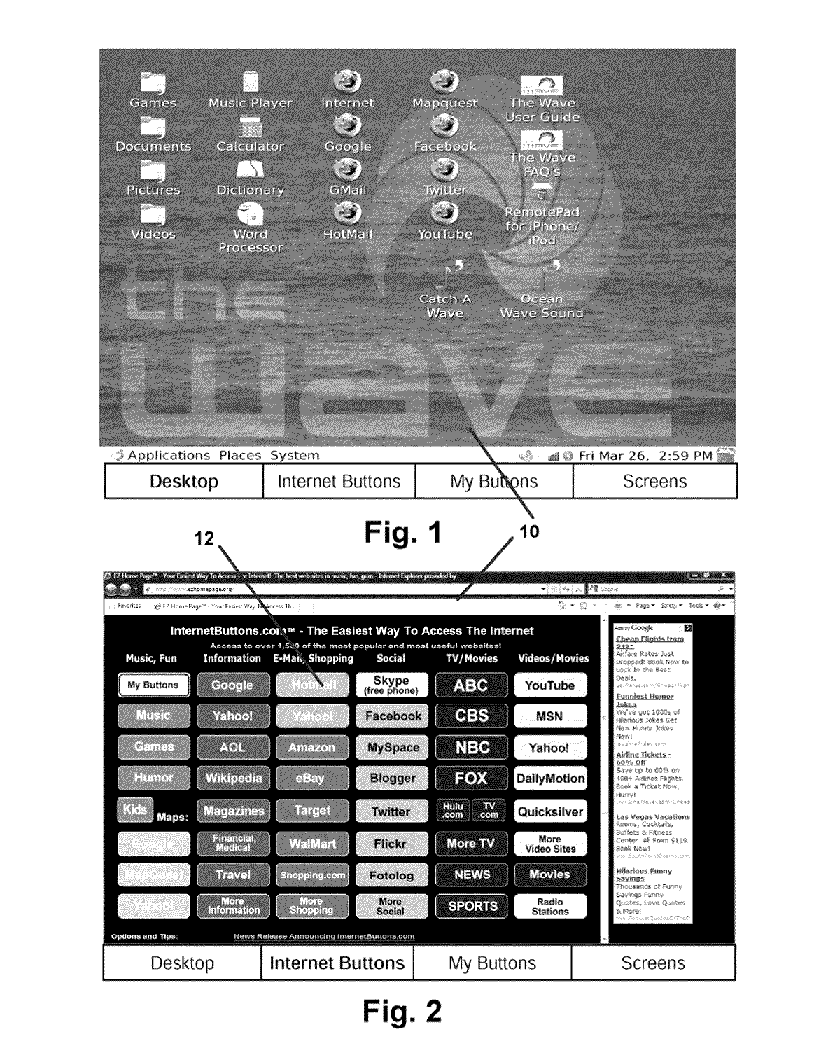

Referring now to the drawings 1-6, wherein similar parts of the disclosed system and apparatus of the disclosed invention are identified by like reference numerals, there is seen in FIG. 1 a depiction of an initial customizable graphical interface typically produced by the system and method herein and changeable by the system herein based on usage by the user over defined durations of time on the internet.

These changes to the graphic interface 10 and displayed links 12 shown in FIG. 2, are based on criteria tracked by software adapted to the task. The current criteria includes one or a combination of criteria from a group including the number and duration of visits to individual web sites, related web sites, links on each of the visited web sites, links taken by the user on any of the visited web sites, and repeat visits to individual web sites or the links on any of the individual web sites, and a continuously changing database of known or researched web sites related to or offering similar content to web sites visited by the user. The system in an ongoing fashion, adapts one or a plurality of graphic interface 10 pages adapted to the individual users habits. The system does so without input from the user by changing the icons and links based on software using the above referenced criteria on an ongoing basis.

FIG. 2 shows the graphic interface 10 assembled over time according to the device and method herein, and continually updated by background software adapted for monitoring internet usage and passively generate new icons or buttons 12 and to rearrange currently displayed icons or buttons 12.

The interfaces 10 compiled by the system will be assembled employing the aforementioned analytical software which is adapted to monitor and to ascertain the inputs of the user using the mouse and icon clicks and keyboard entries. In the aforementioned fashion, the software running on the computer processor herein, will compile one or a plurality of graphic interface pages to be employed as home pages. Each of which will be adapted to the personal web browsing historical actions of the user, both past and present.

By continually monitoring all of the user's inputs for text and mouse inputs, the system can ascertain “chained” actions such as moving to secure sites, inputting passwords, and moving to specific areas of those secure sites. Thereafter, the system can automate the process in a macro computer routine using software adapted to that task, and provide a single button or icon for the user to click upon and perform all of the actions noted in the background. Based on individual sites visited and chained inputs of the users to visit specific sites, on an ongoing basis, the software adapted to the task ascertains and provides new icons or buttons to automate the process. The user-customized icons or links are placed on the graphic interface pages for the specific user, and rearranged based on use.

The system will employ software adapted to run on a PC type processor of the user's computer, or on a remote server of an internet service provider. Inputs to either type of system will employ a mouse or trackball and a keyboard for specific user input both of which are preferably wireless but may be wired. The display may be a conventional computer display engaged to a computer, or in the case of a service provider providing the system on a remote server or the user's computer, it may also be a television. In either case, the device and method is adapted for the use of multiple graphic interface screens on the individual display screens. The PC processor will be connected to the television or display using a conventional cable adapted to the task. If a remote server of a cable internet provider or telephone internet provider is running the system, a local interface device will just need to communicate user inputs to the server, and server graphic output to the user's display.

The TV and PC electronics for the disclosed system are configured to run the software adapted to the aforementioned tasks and includes combinations of the following chips/functions: A microprocessor/CPU, a System Controller/Northbridge, Memory/DRAM, a Peripheral Input/Output (I/O) Bus Controller/Southbridge, a Basic Input/Output System chip (BIOS), a Mass Storage Memory (a Hard Disk/HD or Solid-State Disk/SSD), an Ethernet Network/LAN Controller, Wireless functions (such as Bluetooth and Wi-Fi/802.11), and Audio Controller & Amplifier, and various connectors (such as DC Power, Audio, Video, Ethernet, USB, Memory Card). However, those skilled in the art will realize that other electronic components can and will provide the required processing and such is anticipated. The software adapted to the various tasks of providing the user-monitoring and graphic interface generation and alteration based on user actions and input would be adapted to run on the system locally or on a server communicating through a local interface device with the user's mouse and keyboard and video display.

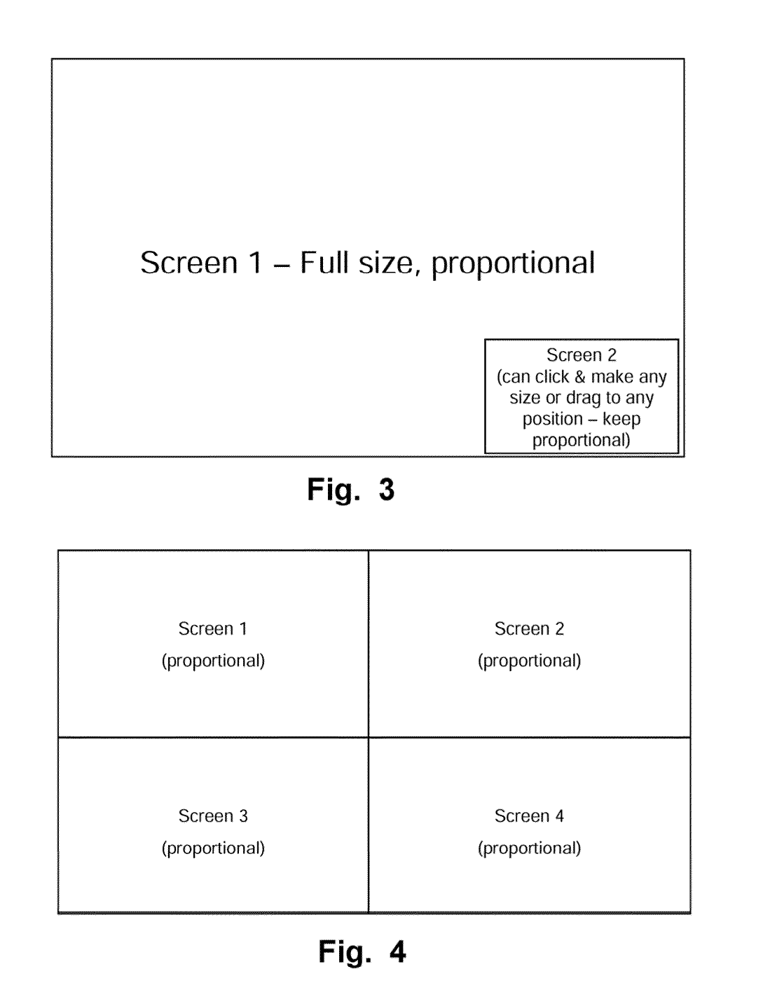

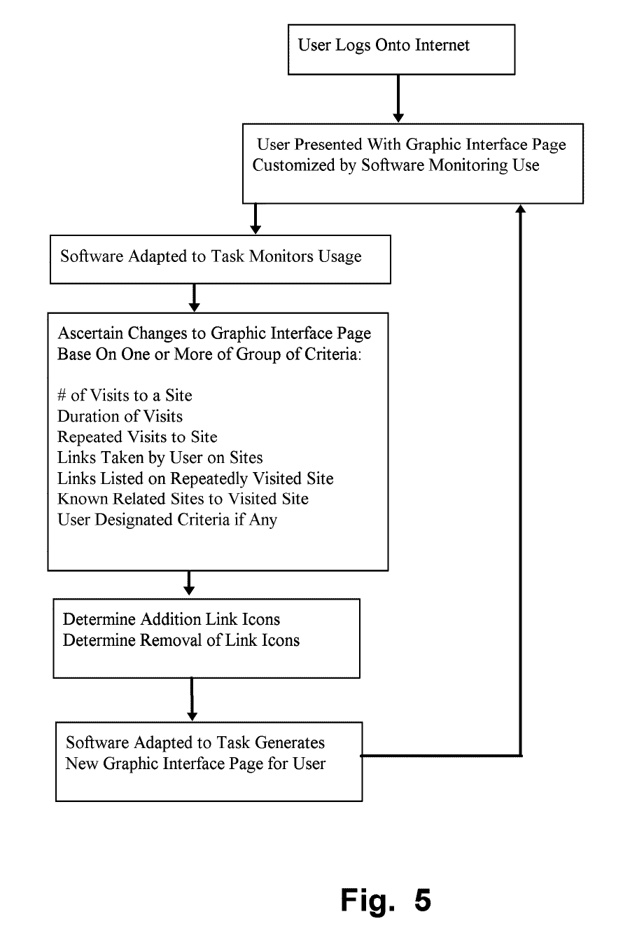

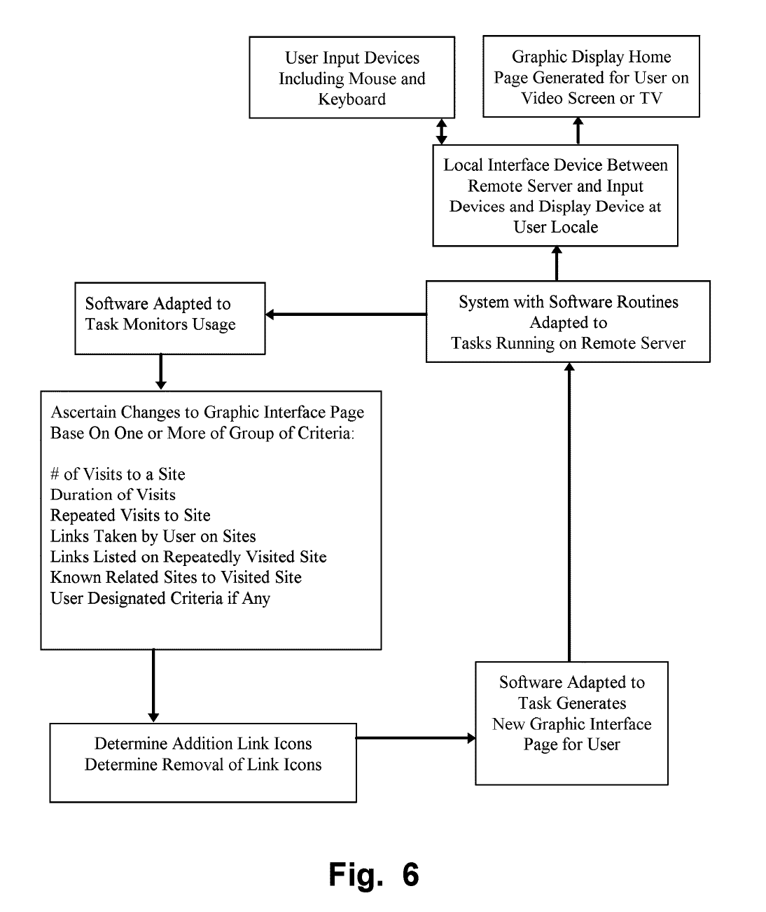

FIGS. 3 and 4 depict the system and method herein employed to control multiple individual screen as displayed on televisions.

While all of the fundamental characteristics and features of the disclosed method and apparatus for tracking usage by individual users and customizing graphic interfaces based on past and ongoing internet use, have been shown and described, a latitude of modification, various changes and substitutions are intended in the foregoing disclosure. It will be apparent that in some instance, some features of the invention may be employed without a corresponding use of other features, or steps may be rearranged for operations, without departing from the scope of the invention as set forth. It should be understood that any such substitutions, modifications, and variations, may be made by those skilled in the art, without departing from the spirit or scope of the invention. Consequently, all such modifications and variations are included within the scope of the invention as defined herein.

What is claimed is:

1. A method employing software running on a data processor for producing displayable customized graphic interfaces for depiction on a video display to users comprising:
employing software to run on a processor, said software configured to employ tracking criteria of use of individual user's;
employing said software to create new a user-customized graphic interface to operate as a user homepage;
employing said software to create icons on said homepage which link to web sites, said icons determined by said tracking criteria;
allowing said user to input choices of said icons using input devices including one or a combination of input devices including a mouse, trackball, and keyboard; and
employing said software ongoing to continually monitor said user's internet usage and to add new said icons to said homepage and adjust the positions of existing said icons on said homepage based on said tracking criteria.

2. The method of claim 1 wherein said tracking criteria employed by said software is one or a combination of tracking criteria from a group including: the number and duration of visits to individual web sites, related web sites, links on each of the visited web sites, links taken by the user on any of the visited web sites, repeat visits to individual websites; the links on any of the individual websites, and a database of known or researched websites related to or offering similar content to websites visited by the user.

2. The method and apparatus of claim 1 also including:
creating action icons on the homepage which emulate user sequences of multiple inputs including keyboard key input, mouse operations and screen cursor positioning, to visit a website destination requiring the same multiple inputs every time.

3. The method and apparatus of claim 2 also including:
creating action icons on the homepage which emulate user sequences of multiple inputs including keyboard key input, mouse operations and screen cursor positioning, to visit a website destination requiring the same multiple inputs every time.

4. The method and apparatus of claim 1 also including:
employing said software to provide statistics to users on their internet use over time; and
employing said statistics to either provide suggested links or automatically generate said links on said home page provided to the user.

5. The method and apparatus of claim 2 also including:
creating action icons on the homepage which emulate user sequences of multiple sequential inputs including keyboard key input, mouse operations and screen cursor positioning, to visit a website destination requiring the same multiple inputs every time.

6. The method and apparatus of claim 3 also including:
creating action icons on the homepage which emulate user sequences of multiple sequential inputs including keyboard key input, mouse operations and screen cursor positioning, to visit a website destination requiring the same multiple inputs every time.

7. The method and apparatus of claim 1 also including:
configuring said software running on a data processor to operate on a remote server;
configuring said software operating on said server to provide communication from said user input devices through a local electronic interface device;
configuring said software operating on said server to generate said homepage to said electronic interface; and
configuring said electronic interface to communicate with said display viewed by said user, whereby a local computer to run said software enabling said method herein is not required.

8. The method and apparatus of claim 2 also including:
configuring said software running on a data processor to operate on a remote server;
configuring said software operating on said server to provide communication from said user input devices through a local electronic interface device;
configuring said software operating on said server to generate said homepage to said electronic interface; and
configuring said electronic interface to communicate with said display viewed by said user, whereby a local computer to run said software enabling said method herein is not required.

9. The method and apparatus of claim 3 also including:
configuring said software running on a data processor to operate on a remote server;
configuring said software operating on said server to provide communication from said user input devices through a local electronic interface device;
configuring said software operating on said server to generate said homepage to said electronic interface; and
configuring said electronic interface to communicate with said display viewed by said user, whereby a local computer to run said software enabling said method herein is not required.

10. The method and apparatus of claim 4 also including:
configuring said software running on a data processor to operate on a remote server;
configuring said software operating on said server to provide communication from said user input devices through a local electronic interface device;
configuring said software operating on said server to generate said homepage to said electronic interface; and
configuring said electronic interface to communicate with said display viewed by said user, whereby a local computer to run said software enabling said method herein is not required.

11. The method and apparatus of claim 1 also including:
providing said software configured to allow said user to email a said icon to a third party.

12. The method and apparatus of claim 2 also including:
providing said software configured to allow said user to email a said icon to a third party.

13. The method and apparatus of claim 3 also including:
providing said software configured to allow said user to email a said icon to a third party.

14. The method and apparatus of claim 4 also including:
providing said software adapted to allow said user to email a said icon to a third party.
